(19) United States
(12) Patent Application Publication
(10) Pub. No.: US 2010/0188335 A1
(43) Pub. Date: Jul. 29, 2010

(54) Navigation Handling within Web Pages

(75) Inventors: Clinton Priddle, Upplands Vasby (SE); Stefan Ålund, Enskede (SE); Per-Erik Brodin, Sollentuna (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 12/665,725

(22) PCT Filed: Jun. 27, 2008
(86) PCT No.: PCT/IB2008/003111

§ 371 Date: Dec. 20, 2009

Related U.S. Application Data
(60) Provisional application No. 60/929,466, filed on Jun. 28, 2007.

(51) Int. Cl. G06F 3/033; G06F 3/048

(52) U.S. Cl. 345/161; 715/760; 715/810

(57) ABSTRACT

A web application (630) for a web browser that is downloaded as a web page includes a set of links arranged as a matrix array (633) with the links being invisible on a display of a device running the web browser, and scripting logic (635) for maintaining focus of a navigator of the device on a center one of the links in the matrix array and for updating the web browser to reflect a function associated with an activation of the navigator.

### BACKGROUND

This invention relates to mobile browsers and more particularly to a method for providing improved functionality to navigation within mobile browsers via the navigator of a mobile device.

The phenomenal increase in the use of mobile communication devices is well known. As the mobile communication technology has evolved, the mobile device has been relied upon for performing increasingly complex functions. For example, the early mobile devices were used solely for voice communications. In succeeding generations, the mobile devices were provided with functionality for sending text messages in addition to being used for voice communications, for facilitating the submission/reception of electronic mail, and for accessing and browsing networks such as the interne. Mobile devices are also used as image capturing devices and for receiving and displaying television broadcast signals. The mobile device is being viewed upon as a combination of a mobile computing device and a mobile communication device. Tasks routinely performed on desktop or mobile computers are being migrated to the mobile communication devices.

In order to use the mobile device to access the World Wide Web, for example, web browsing applications (i.e. web browsers) for mobile devices have been developed and implemented. A mobile web browsing application is similar to a browser application (such as Internet Explorer®, Mozilla Firefox®, etc.) for personal computers. The content downloaded from the web may be adjusted for the smaller screen associated with a mobile device. Web browsing applications running on a mobile device are also referred to herein as mobile web browsers or mobile web browsing applications.

In some mobile devices, the basic keypad of a mobile device (keys for 0, 1, . . . , 9, * and #) has been replaced by a full keypad (including the entire alphabet, the ten digits and special symbols found on computer keyboard). Some mobile devices also include a “joystick” (also referred to as a “navigator”) which can be used to navigate horizontally (from left to right and vice versa) as well as vertically (from top to bottom and vice versa) within an user interface of the mobile device. A set of arrow (or, directional) keys, pointing in each of left, right, up and down directions are included in some devices for facilitating navigation.

Navigation within the downloaded content in a browser is presently limited to link to link navigation using the joystick for example. Increasingly, web applications are being developed that can be downloaded into the mobile web browsers as web content; these web applications emulate a regular application. These applications may include games, word processing, spread sheets, electronic mail, etc.

The navigation means (such as an extended keyboard, the arrow keys or the joystick) do not provide the user with an adequate ability for navigating through content associated with these web applications (that emulate a regular application in a mobile web browser). This is due partly to the fact that these web applications provide features and functionality that cannot be accessed or invoked in just a link to link manner.

HTML (HyperText Markup Language) is written using tags. While HTML was intended to represent the logical structure of a text document, the physical representation of headings, paragraphs, etc. was determined by the browser. Ultimately, more control over the visual appearance of web pages was sought. Tags such as the font tag were introduced, allowing web developers to specify the typeface, size, weight and color of text in HTML documents. Using table elements with zero-width borders, it was possible to do fairly advanced layout and positioning of page contents. The markup became cluttered and hard to comprehend. Today, HTML is once again written to represent the structure of documents while presentation related formatting is handled by CSS (Cascading Style Sheets). In recent years, web applications have emerged, which are web pages that try to emulate or mimic the behaviour of a regular application.

What is desired, therefore, is a mechanism for providing the navigator of a mobile device with ability to navigate within web applications (or web content) that emulate or mimic a regular application in a mobile web browser.

### SUMMARY

Among other things, this invention solves the problem associated with using a navigator such as a joystick within a web application running in a mobile web browser.

In an exemplary embodiment, a web application for a web browser is disclosed. The web application comprises a set of links arranged as a matrix array, the links being invisible on a display of a device running the web browser; and scripting logic for maintaining focus of a navigator of the device on a center one of the links in the matrix array and for updating the web browser to reflect a function associated with an activation of the navigator, wherein the web application is downloaded as a web page.

In another embodiment, a method of navigation within a web application is disclosed. The web application runs in a browser of a mobile device and includes a set of links arranged as a matrix array, the links being invisible in the browser, and scripting logic for maintaining focus of a navigator of the device on a center one of the links in the matrix array. The method of navigation comprises activating the navigator, the activation comprising moving the navigator in a particular direction; getting a focus for an invisible link adjacent to the center link in the matrix array in a direction corresponding to the particular direction; updating the web browser reflecting a function associated with the activation of the navigator; and returning focus of the navigator to the center link in the matrix array.

In a further embodiment, a mobile communication is disclosed. The mobile communication device comprises a browser application running on the device; a navigator for providing navigation within a display of the device; and a web application downloaded into the browser, the application including a set of links arranged as a matrix array, the links being invisible on the display; and scripting logic for maintaining focus of the navigator on a center one of the links in the matrix array.

### BRIEF DESCRIPTION OF THE DRAWINGS

The various features, advantages, and objects of this invention will be understood by reading this description in conjunction with the drawings, in which:

FIG. 1 illustrates a mobile communication device;

FIG. 2 illustrates a matrix array of links downloaded with the application in exemplary embodiments;

FIG. 3 illustrates an exemplary invisible matrix array of links and a corresponding application for navigator activation;

FIG. 4 illustrates a method of navigation within a web application in a web browser according to exemplary embodiments;

FIG. 5 illustrates an exemplary mobile communication device; and

FIG. 6 illustrates an exemplary web application.

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

The Document Object Model (DOM) is a programming interface that enables users to manipulate contents of a web page. DOM provides an object-oriented representation of the contents of the page. Objects can be added or removed to create dynamic content on the page.

Generally, the use of a mouse includes moving the mouse, selecting an element (by clicking), opening an element (by double clicking), etc. The user activation of the mouse such as clicking or double clicking is designated as an “event” within the browser.

Event handlers facilitate the creation of dynamic web pages. A script code can be executed in response to user actions. The DOM provides the ability for capturing events such as mouse movement, button or key clicks, etc. However, there are no events associated with joystick movements.

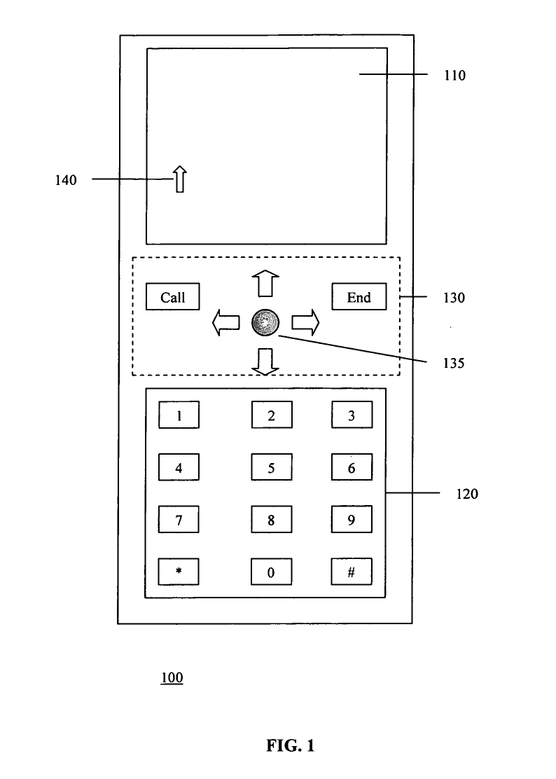

An exemplary mobile device 100 is illustrated in FIG. 1. Mobile device 100 includes a display area 110, a keypad 120, a plurality of soft keys 130 including the joystick 135 or a set of directional keys. A browser application running on a mobile device facilitates viewing of content from a particular website for example (similar to browsing on a computer) and navigation in a link to link manner.

As highlighted, while the navigation described above is adequate for selecting links within a web browser or navigating (or, jumping) between links, the present navigator is inadequate for moving or navigating through content associated with a web application in a mobile web browser.

Due to the lack of events being associated with joystick movement as described above, the ability to navigate (beyond link to link) within web applications running in a mobile web browser is not available to users. For example, the navigator cannot be used to move a displayed object from one screen location to another screen location. The ability to select and navigate through a drop-down menu is also not available.

In the DOM events described above, there is an event called “focus” which may be described as firing when an element receives focus either via a pointing device or by tab navigation. This may be valid for a browser application on a personal computer. On a mobile computing device, however, such events will be fired when the joystick is used to focus an element. This may occur, for example, when a link that was not previously highlighted is being highlighted by the joystick. In exemplary embodiments, focus events that are triggered when links are highlighted may be used to emulate events fired as a result of moving the joystick. The emulated events may trigger scripting logic in the application so that the user interface may be updated, for example, to move an object using the joystick.

Scripting logic (e.g. JavaScript™) for facilitating this functionality may be inserted or embedded into a web application (or web content or web page). The web content (or web application) may be downloaded into a mobile web browser and may describe the application. The web content may also include (in an HTML form) a set of invisible links. The links may be arranged as an array; in some embodiments, the links may be arranged as a 3 by 3 matrix. These links are not visible within the mobile browser running the web application. The scripting logic sets or maintains the focus of the joystick to a central one of the invisible links within the 3 by 3 matrix. Exemplary HTML and scripting logic is listed in Appendix I.

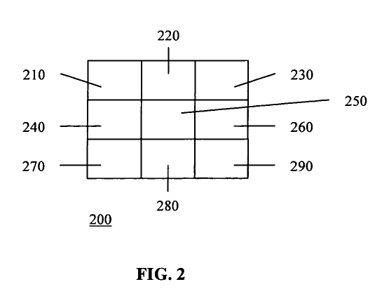

An exemplary 3 by 3 matrix 200 (that is invisible in the web browser) is illustrated in FIG. 2A. Matrix 200 may include nine locations 210-290. The focus of the joystick may always be set to the center location 250. If the joystick is moved in any direction (i.e. up, left, right or down) such as one of the neighboring locations 220, 240, 260 and 280 for example, a focus event for the particular link (i.e. corresponding to the up, left, right or down directions) may be fired and the corresponding function may be invoked or executed. The focus may always be returned (or, reset) to the center location 250.

While the shifting of focus from the center location within the array matrix is not visible to the user or in the web browser, the result of invoking or executing the corresponding function is visible.

In an exemplary embodiment, movement of the joystick may correspond to moving an object in a user interface of the mobile device. The user interface may correspond to a display of the mobile device for example. This may be applicable in a gaming environment. That is, a web gaming application may be running on the device and the joystick may be used to move an object within the user interface or display area.

Referring to FIG. 2 for example, the focus may initially be on the invisible center link 250. The navigator may be moved to the right to move the object to the right. In response, the focus for link 260 may be obtained (i.e. getting focus). An object may be moved to the right and focus may return to center link 250. A user will not see the focus shifting between the links as the links (i.e. in the form of a three by three matrix) are not visible. However, the movement of the object to the right is visible to the user. The browser is therefore, updated to reflect the movement of the object.

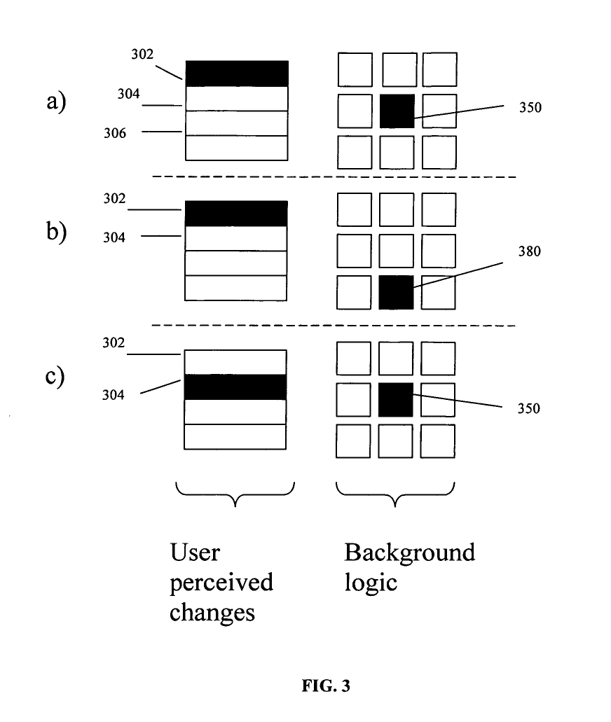

In other embodiments, the navigator may be used to navigate within a menu system (drop down) such as that illustrated in FIG. 3 along with an invisible matrix array of links. Initially, (first) menu item 302 may be in focus (The focus within the matrix array is also at the center link 350). A user may wish to access (second) menu item 304. The navigator (i.e. joystick) may be moved in the down direction. This movement causes an event that may be caught by the background logic associated with the invisible matrix array. The navigator movement leads to getting focus on invisible link 380. Focus within the menu may now shift to menu item 304. Focus within the invisible links returns to center link 350. Similarly, if the user wants to access third menu item 306 for example, the joystick may be moved down to get focus for invisible link 380 resulting in focus on the menu shifting to menu item 306 and returning focus in the invisible links to center link 350. If the user now wants to access menu item 304 again, then the joystick may be moved up to get focus for invisible link 320 resulting in focus on the menu shifting to menu item 304 and focus in the invisible links returns to center link 350.

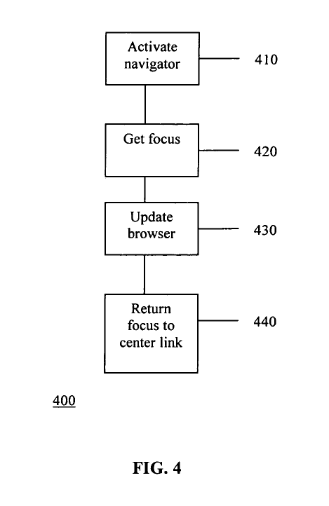

A process or method 400 for navigating within a web application according to exemplary embodiments is illustrated in FIG. 4. The web application may be running in a web browser of a mobile device. The web application may have been previously downloaded as a web page for example. The web page may include a set of invisible links arranged as a matrix array. The web page may also include scripting logic for maintaining focus of the navigator of the device on the center one of the invisible links. The invisible links and the scripting logic may be downloaded as part of the web page for example.

While the application is running within the browser, the navigator may be activated at 410. Activation may correspond to the navigator (i.e. joystick) being moved in one direction such as up, down, left or right for example. In response to the activation of the navigator, focus may be obtained at 420. The focus may be obtained for an invisible link that is adjacent to the center link in the direction of the navigator movement (i.e. one of up, down, left or right). The web page (or, contents of the web page within the web browser) may be updated at 430 to reflect the navigator activation or movement. The updating may be moving an object or shifting focus within a menu as highlighted above. Focus within the invisible links is returned to the center link at 440.

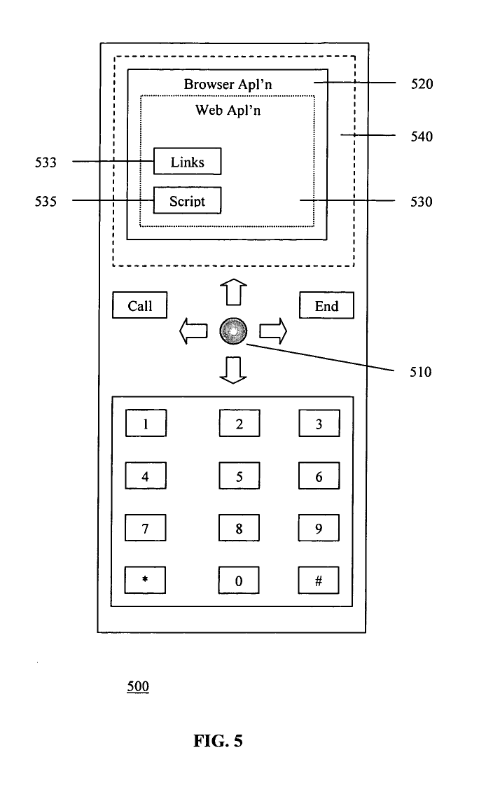

As illustrated in FIG. 5, an exemplary mobile communication device 500 may include a navigator 510 and display 540. A browser application 520 may be running on the communication device 500. A web application 530 may be downloaded and may be running within browser 520. The web application may include a set of links 533 arranged as a matrix array (FIG. 2) with the links being invisible to a user or within the application on the display. The web application may also include scripting logic 535 for maintaining focus of the navigator on the center one of the links in the matrix array.

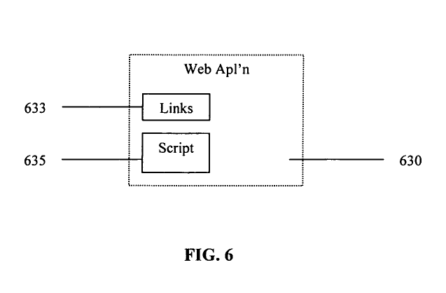

A web application 630 is illustrated in FIG. 6. Web application 630 may include a set of links 633 and scripting logic 635 as described above.

While exemplary embodiments have been described with respect to navigation within a menu or moving of an object, the present invention is not limited to these specific examples. Other functions for specific web applications may be implemented utilizing exemplary embodiments. Other navigators may also be utilized (in addition to or in place of a joystick).

The type of functionality available to the user in an application may be known to the user or made available to the user prior to downloading or using the application. This may be achieved via documentation or preferably, it may be intuitive. The shift of focus from the center link as a result of moving the joystick in any direction (i.e., left, right, up or down) is not visible to the user but the result of firing of a focus event for the neighboring link is apparent (such as an object moving from one position to another position on the user interface or screen).

The information downloaded to facilitate the invisible link matrix may vary from application to application and therefore different information may be downloaded depending on the application that is being accessed.

Exemplary embodiments may also be applicable to a user input device used in internet protocol television (IPTV) systems. In an IPTV system, the web browser may be specific to the IPTV system.

Exemplary embodiments as described above facilitate navigation within many different types of web content; navigation is no longer limited to web content containing only links (i.e. link-to-link navigation). The web content includes assigning specific functionality to each of the invisible links for each application that is downloaded into the browser application of a mobile communication device.

It is expected that this invention can be implemented in a wide variety of environments, including for example mobile communication devices. It will also be appreciated that procedures described above may be carried out repetitively as necessary. To facilitate understanding, aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

It is emphasized that the terms “comprises” and “comprising”, when used in this application, specify the presence of stated features, integers, steps, or components and do not preclude the presence or addition of one or more other features, integers, steps, components, or groups thereof.

Thus, this invention may be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

### APPENDIX I

Snippet of HTML to facilitate the matrix:

<div id=“matrix of links”>
X<a id=“up” href=“#”>X</a>X<br>
<a id=“left” href=“#”>X</a><a id=“center” href=“#”>X</a><a id=“right” href=“#”>X</a><br>
X<a id=“down” href=“#”>X</a>X<br>
</div>

Snippet of JavaScript code to set focus on the center link and to register focus listeners on the other links in the matrix:

document.links[“center”].focus( );
document.links[“left”].addEventListener(“focus”, got_focus, false);
document.links[“right”].addEventListener(“focus”, got_focus, false);
document.links[“up”].addEventListener(“focus”, got_focus, false);
document.links[“down”].addEventListener(“focus”, got_focus, false);

The JavaScript function got_focus( ) contains the logic that will be invoked each time focus is set to one of the links in the matrix (not provided here).

1. A web application for a web browser, the web application comprising:
a set of links arranged as a matrix array, the links being invisible on a display of a device running the web browser; and
scripting logic for maintaining focus of a joystick of the device on a center one of the links in the matrix array and for updating the web browser to reflect a function associated with an activation of the joystick, wherein the web application is downloaded as a web page.

2. The web application of claim 1, wherein the device is a mobile communication device.

3. The web application of claim 1, wherein the device is a set top box.

4. The web application of claim 1, wherein the set of links is embedded in the web application in a hypertext markup language form.

5. (canceled)

6. The web application of claim 1, wherein the matrix array includes three rows and three columns.

7. A method of navigation within a web application in a browser of a mobile device wherein the application includes a set of links arranged as a matrix array, the links being invisible in the browser, and scripting logic for maintaining focus of a joystick of the device on a center one of the links in the matrix array, the method comprising:
activating the joystick, the activation comprising moving the joystick in a particular direction;
getting a focus for an invisible link adjacent to the center link in the matrix array in a direction corresponding to the particular direction;
updating the web browser reflecting a function associated with the activation of the joystick; and
returning focus of the joystick to the center link in the matrix array.

8. The method of claim 7, wherein the directions include left, right, up and down.

9. The method of claim 7, wherein the function is selecting a menu item from a drop down menu.

10. The method of claim 7, wherein the function is moving an object within the browser.

11. The method of claim 7, wherein the web application is downloaded into the web browser as a web page.

12. The method of claim 7, wherein the application is a gaming application.

13. (canceled)

14. A mobile communication device comprising:
a browser application running on the device;
a joystick for providing navigation within a display of the device; and
a web application downloaded into the browser, the application including
a set of links arranged as a matrix array, the links being invisible on the display; and
scripting logic for maintaining focus of the navigator joystick on a center one of the links in the matrix array.

15. The mobile communication device of claim 14, wherein the scripting logic updates the web browser to reflect a function associated with an activation of the joystick.

16. A web application for a mobile web browser, the web application comprising:
a set of links arranged as a matrix array, the links being invisible on a display of a mobile device running the web browser; and
scripting logic for maintaining focus of a joystick of the mobile device on a center one of the links in the matrix array, wherein the web application is downloaded to the mobile device as a web page.

17. The web application of claim 16, wherein the scripting logic updates the web browser to reflect a function associated with an activation of the joystick.
